(19) United States
(12) Patent Application Publication
(10) Pub. No.: US 2013/0303069 A1
(43) Pub. Date: Nov. 14, 2013

(54) DUCT ARCHITECTURE FOR REGULATING CLIMATE ZONE IN A VEHICLE

(71) Applicant: Ford Global Technologies, LLC, Dearborn, MI (US)

(72) Inventors: Mukesh Kumar, Canton, MI (US); Paul Bryan Hoke, Plymouth, MI (US)

(21) Appl. No.: 13/934,932

(22) Filed: Jul. 3, 2013

Related U.S. Application Data
(63) Continuation of application No. 12/389,400, filed on Feb. 20, 2009, now abandoned.

(51) Int. Cl. B60H 1/26

(52) U.S. Cl. CPC B60H 1/26
USPC 454/145

(57) ABSTRACT

A climate control duct architecture having articulated and controlled interior surfaces to deliver variable and controllable airflow to target zones in the vehicle upon demand. By creating zone climates within the vehicle and providing conditioned airflow to only desired vehicle seating positions, the volume of necessary airflow is minimized, the need for cooling is reduced, and flexibility of the system is created. The interior surface may be mechanically or electrically controlled and may be situated in the common central “octopus” duct.

### TECHNICAL FIELD

The present invention relates generally to climate control duct systems for vehicles. More particularly, the present invention relates to a climate control duct architecture having articulated and controlled interior surfaces to deliver variable and controllable airflow to occupants in target zones in the vehicle upon demand. By strategic regulation of the airflow the heating and cooling of different zones can be adjusted to meet the specific needs of vehicle occupants as well as optimize HVAC performance while minimizing energy usage.

### BACKGROUND OF THE INVENTION

Modern vehicle interiors are provided with climate control systems. Central to the climate control system is the HVAC which produces climatized air for distribution into the interior of the vehicle through a variety of ducts. Known arrangements of ducts in climate control systems include a path to the panel registers and to the console which takes place at a distance away from the air outlet of the HVAC. Other than selective closure of the panel registers current designs of vehicle air ducts cannot be regulated. This situation where the control of air flow is inflexible creates a variety of difficulties in that key vehicle occupants sit in different vehicle positions (in the driver seat or in the rear seat) in different markets worldwide. In addition, for a given vehicle, usage entails varying numbers of passengers in different seating positions.

Accordingly, as in so many areas of vehicle design, there is room for improvement whereby a more efficient and flexible arrangement for providing adequate airflow to all vehicle passengers is desired.

### SUMMARY OF THE INVENTION

The present invention represents advancement in the art of vehicle climate control system duct architecture. The arrangement disclosed herein includes a duct having an air inlet for attachment to an HVAC system of a vehicle and a plurality of airflow outlets and a plurality of airflow channels formed between the inlet and the airflow outlets. One or more of the airflow channels have an associated flexible structure for controlling airflow through its adjacent airflow channel. The flexible structure may be either a pivotable door, a movable curtain or another device capable of selectively allowing or halting the passage of airflow. The pivotable door may be used for restricting the flow of air through one or the other of two adjacent airflow channels. The movable curtain may be used for restricting the flow of air through a single airflow channel.

By allowing the selective flow of air through the airflow channels the total volume of air being provided to the duct may be reduced, thus reducing the electrical consumption by the HVAC blower. Similarly the reduced airflow requires less cooling or heating and thus also reduced power required by the HVAC compressor or powered heat sources (such as a PTC [positive temperature coefficient] heater). The arrangement of the present invention thus provides for controlled and optimum airflow throughout the interior of the vehicle with minimum energy requirements.

Other advantages and features of the invention will become apparent when viewed in light of the detailed description of the preferred embodiment when taken in conjunction with the attached drawings and the appended claims.

### BRIEF DESCRIPTION OF THE DRAWINGS

For a more complete understanding of this invention, reference should now be made to the embodiment illustrated in greater detail in the accompanying drawings and described below by way of examples of the invention wherein:

FIG. 1 illustrates a perspective view of an airflow distribution duct of the known art;

FIG. 2 is a sectional view of a portion of an airflow distribution duct having a flap door for regulating airflow according to one variation of the disclosed invention;

FIG. 3 is a sectional view of a portion of an airflow distribution duct having a curtain door for regulating airflow according to another variation of the disclosed invention;

FIG. 4 illustrates a view of the micro-climate control duct architecture of the disclosed invention taken from its air inlet end and illustrating the system adjusted to its chauffer mode with airflow directed only to the rear passengers; and

FIG. 5 is a view similar to that of FIG. 4 but showing the system adjusted to its driver mode with airflow directed only to the driver.

### DETAILED DESCRIPTION OF THE PREFERRED EMBODIMENT

In the following figures, the same reference numerals are used to refer to the same components. In the following description, various operating parameters and components are described for one constructed embodiment. These specific parameters and components are included as examples and are not meant to be limiting.

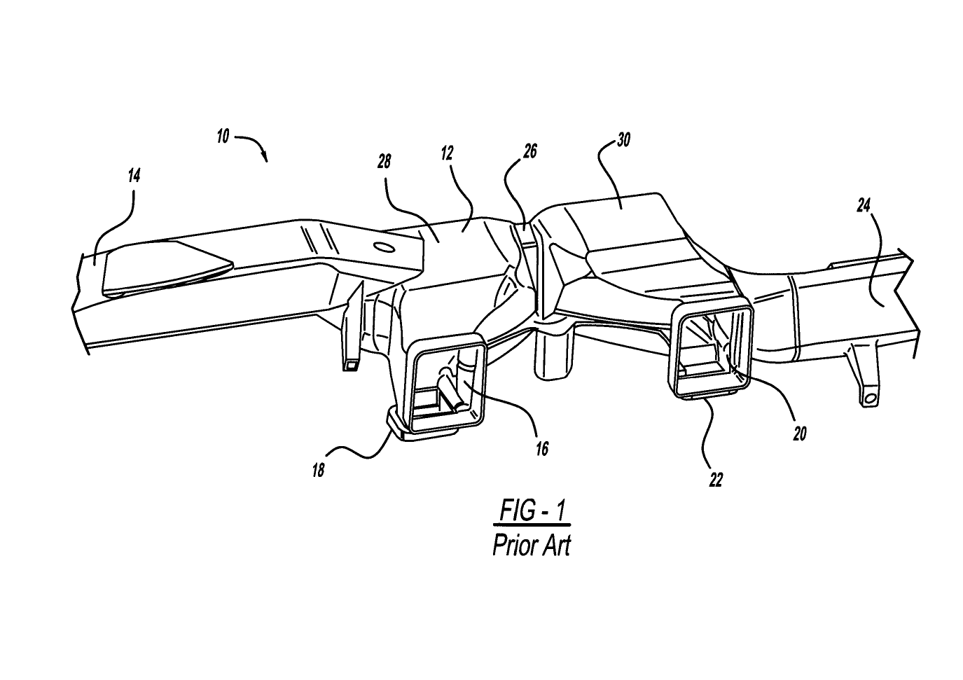

With reference to FIG. 1, a perspective view is shown of an airflow distribution duct according to the known art, generally illustrated as 10. The airflow distribution duct 10 includes a body 12, a first outlet 14, a second outlet 16, a third outlet 18, a fourth outlet 20, a fifth outlet 22, and a sixth outlet 24. There can be a greater or lesser number of outlets as is known in the art and the arrangement shown is only for illustrative purposes as representing the state of the prior art. Of particular interest is the body 12 which conventionally includes a plenum section for receiving inflowing air coming from the HVAC to which individual outlets 14, 16, 18, 20, 22 and 24 are connected. Conventionally illustrated in FIG. 1 is the body 12 having two plenum volumes, including a first plenum volume 28 and a second plenum volume 30, both being provided for fixed zone climate control to the passenger and driver respectively. According to the prior art airflow to different regions is fixed by default duct geometry and can only be regulated by adding restrictions (resulting in loss of air flow) or by adjusting the total airflow by, for example, the use of a blower.

According to the known art, regulation of the airflow to different occupant regions is only controlled by the panel vents (not shown). This arrangement is challenging for several reasons. First, air is still being pushed throughout the duct resulting in excess electrical consumption by the HVAC blower. Second, cooling/heating of the vehicle, even with certain panels closed, is still inefficient since cold/hot air is still also being pushed throughout the duct resulting in extra power required by the HVAC compressor. Third, when a vehicle is occupied by the operator alone, it is not convenient for the operator to adjust the panel doors to compensate for the absence of other vehicle occupants from the driver's seat.

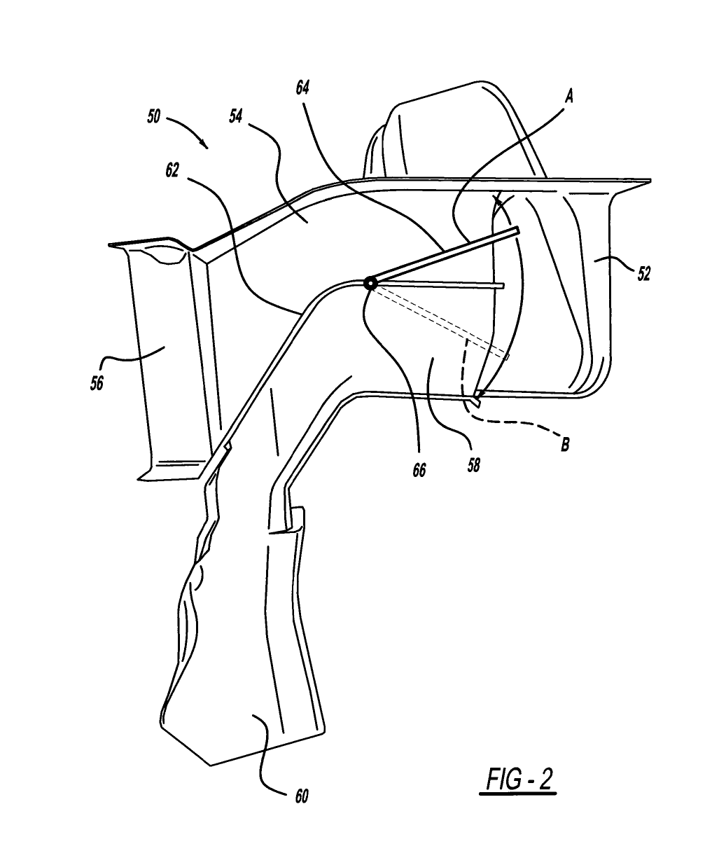

The disclosed invention in its various embodiments, as disclosed in FIGS. 2 through 5, provides a solution to the challenges encountered by designers of current systems. With reference to FIG. 2, a sectional view of a portion of an airflow distribution duct, generally illustrated as 50, is shown. The airflow distribution duct 50 includes an inlet 52 adapted for attachment to an HVAC outlet (not shown), an upper airflow chamber 54 which is in fluid communication with an upper outlet 56 (fluidly associated with an instrument panel outlet), and a lower airflow chamber 58 which is in fluid communication with a lower outlet 60 (fluidly associated with an octopus duct system for delivery to the rear occupants of the vehicle). The upper airflow chamber 54 is separated from the lower airflow chamber 58 by a partition 62. It is to be understood that the illustrated airflow distribution duct 50 is set forth for demonstrative purposes only and is not intended as being limiting as the disclosed invention can be readily adapted for use in a variety of duct configurations. For example, the disclosed invention may be adapted for use with rear ducts, console ducts, or B-pillar ducts.

To regulate airflow a flap door 64 is provided between the upper airflow chamber 54 and the lower airflow chamber 58. The flap door 64 is pivotably attached at hinge point 66 at a position adjacent to the partition 62.

The flap door 64 is pivotably movable between two positions, A and B. When moved to position A the flap door 64 substantially blocks incoming air from entering the upper airflow chamber 54 and instead directs the incoming air into and through the lower airflow chamber 58. When moved to position B the flap door 64 substantially blocks incoming air from entering the lower airflow chamber 58 and instead directs the incoming air to the upper airflow chamber 54. It is to be noted that positions A or B may be chosen to completely block the upper airflow chamber 54 and the lower airflow chamber 58.

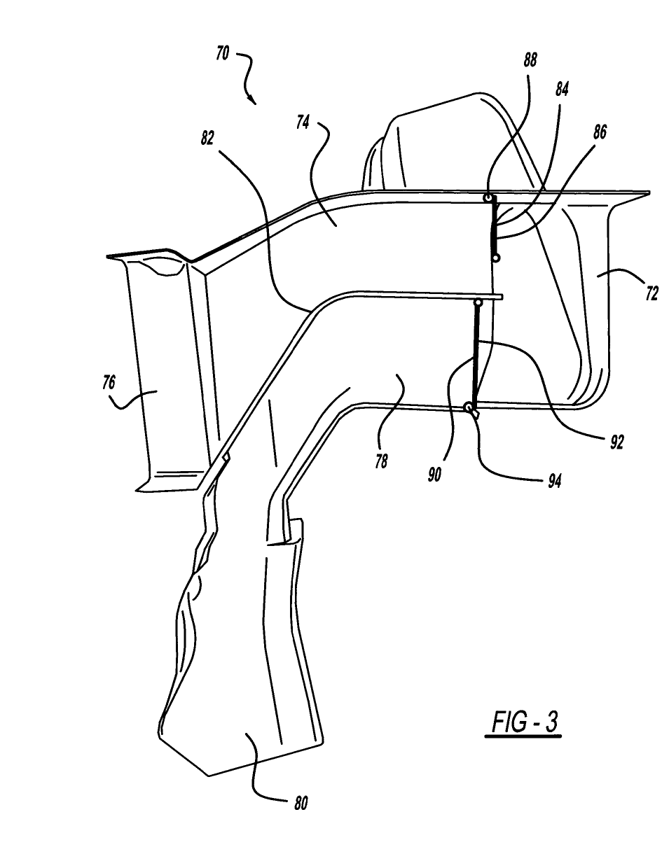

The flap door 64 illustrated in FIG. 2 is one approach to selectively regulate airflow according to the disclosed invention. An additional approach is illustrated in FIG. 3. With reference thereto, a sectional view of a portion of an airflow distribution duct, generally illustrated as 70, is shown. The airflow distribution duct 70 includes an inlet 72 adapted for attachment to an HVAC outlet (not shown), an upper airflow chamber 74 which is in fluid communication with an upper outlet 76 (fluidly associated with an instrument panel outlet), and a lower airflow chamber 78 which is in fluid communication with a lower outlet 80 (fluidly associated with an octopus duct system for delivery to the rear occupants of the vehicle). The upper airflow chamber 74 is separated from the lower airflow chamber 78 by a partition 82. As with the airflow distribution duct 50 shown in FIG. 2 and discussed in relation thereto, it is to be understood that the illustrated airflow distribution duct 70 is set forth for demonstrative purposes only and is not intended as being limiting as the disclosed invention can be readily adapted for use in a variety of duct configurations.

To regulate airflow within the airflow distribution duct 70 a curtain door system is provided. Particularly, an upper airflow curtain assembly 84 is provided adjacent the opening of the upper airflow chamber 74. The upper airflow curtain assembly 84 includes a flexible curtain door 86 and a roller/retractor 88. The flexible curtain door 86 preferably rides on a pair of opposed tracks (not shown) attached to the walls of the duct. As illustrated the flexible curtain door 86 is shown in its partially closed position. In this position the airflow into the upper airflow chamber 74 is partially restricted.

A lower airflow curtain assembly 90 is provided adjacent the opening of the lower airflow chamber 78. The lower airflow curtain assembly 90 includes a flexible curtain door 92 and a roller/retractor 94. The flexible curtain door 92 preferably rides on a pair of opposed tracks (not shown) attached to the walls of the duct. As illustrated the flexible curtain door 92 is shown in its fully closed position. In this position the airflow into the lower airflow chamber 78 is fully restricted.

The use of the flap door and the curtain door is not mutually exclusive and the different types of doors may be employed in a single system. Furthermore, while the flap door 64 of FIG. 2 and the airflow curtain assemblies 84 and 90 of FIG. 3 are illustrated in a particular arrangement, it is to be understood that the illustrated arrangement is not intended as being limiting but is intended as being broadly instructive. Other variations are conceivable. For example, while the flexible curtain doors 86 and 92 are illustrated as being movable in the vertical direction it is envisioned that the flexible curtain doors could instead be movable in the horizontal direction.

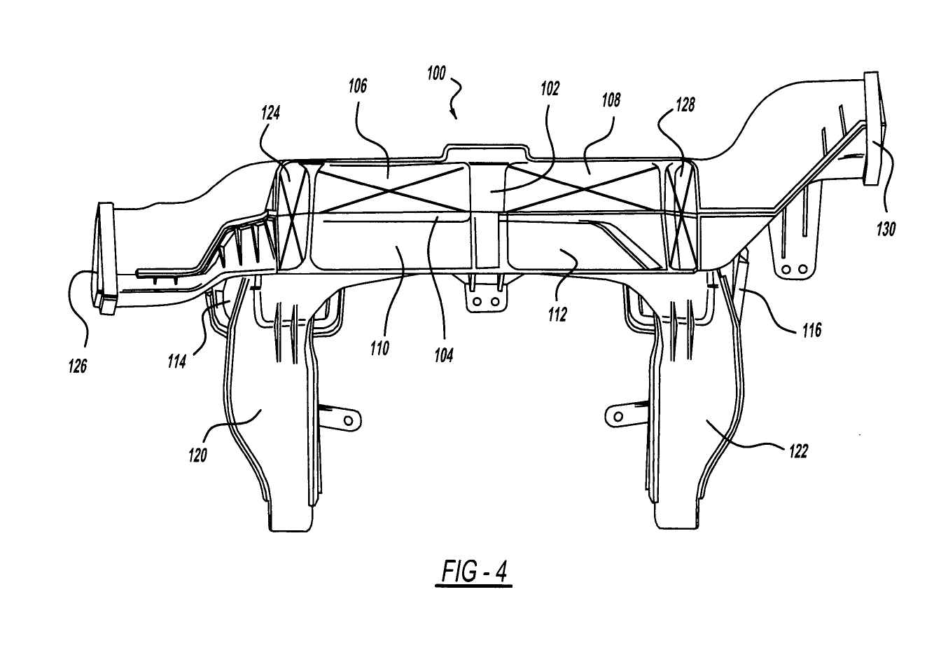

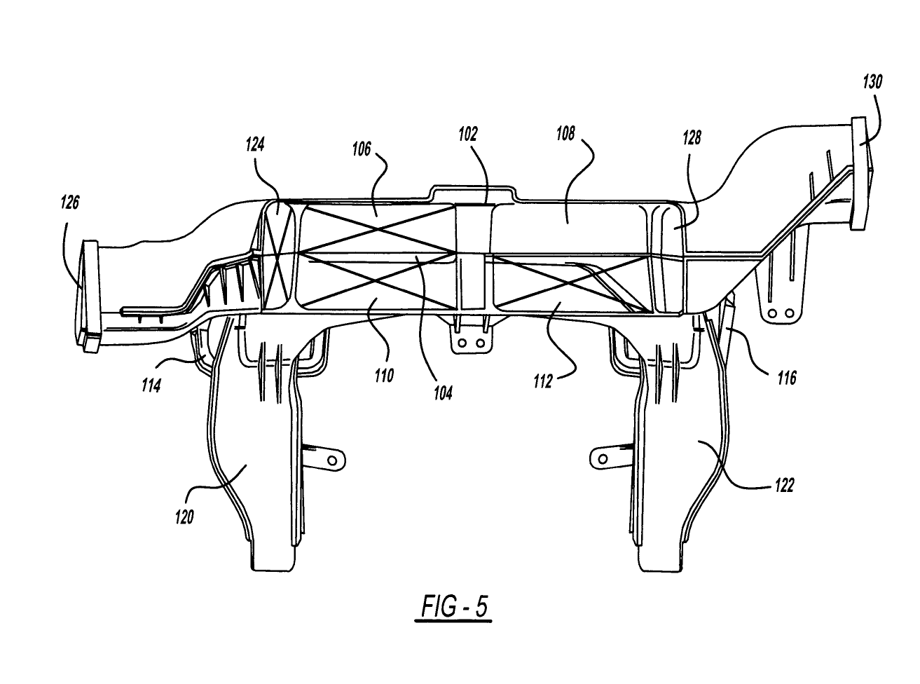

The flap door 64 or the airflow curtain assemblies 84 and 90 may be used in any of several duct architectures. One such architecture is shown in FIGS. 4 through 5 in which a vehicle duct system, generally illustrated as 100, is illustrated from its inlet side. As illustrated, the inlet side is divided into a number of channels by the central vertical divider 102 and the central horizontal divider 104. The channels include a first airflow channel 106, a second airflow channel 108, a third airflow channel 110, and a fourth airflow channel 112. The first airflow channel 106 is fluidly continuous with a fourth airflow outlet 114, the second airflow channel 108 is fluidly continuous with a second airflow outlet 116, the third airflow channel 110 is fluidly continuous with a fifth airflow outlet 120, and the fourth airflow channel 112 is fluidly continuous with a third airflow outlet 122.

In addition to the first airflow channel 106, the second airflow channel 108, the third airflow channel 110, and the fourth airflow channel 112, a fifth airflow channel 124 is provided in fluid communication with a sixth airflow outlet 126 and a sixth airflow channel 128 is provided in fluid communication with a first airflow outlet 130. It is to be understood that a greater or lesser number of airflow channels may be provided. However, regardless of the number of channels, the dividers which define the channels are substantially adjacent with and may abut directly against the outlet of the HVAC.

By incorporating the flap door or the airflow curtain assemblies discussed above and illustrated in the figures, one or more of the airflow channels can be completely or partially closed within the duct architecture, thus allowing the flow of air only to selected occupant areas. For example, and with specific reference to FIG. 4, the first airflow channel 106, the second airflow channel 108, the fifth airflow channel 124, and the sixth airflow channel 128 are shown to have been blocked off by either (or both) a flap door or an airflow curtain. Conversely, the third airflow channel 110 and the fourth airflow channel 112 are either partially or fully open, thus allowing air to pass to the fifth airflow outlet 120 and the third airflow outlet 122. This mode is the “chauffer mode” in which air is directed to the rear passengers only

The closing of certain airflow channels and the opening of other airflow channels shown in FIG. 4 is only one of several possible arrangements that could be selected given the construct of the disclosed invention. By way of further example, and with specific reference to FIG. 5, the first airflow channel 106, the third airflow channel 110, and the fifth airflow channel 124 are shown to have been blocked off by either (or both) a flap door or an airflow curtain.

Conversely, the second airflow channel 108 and the sixth air flow channel 128 are either partially or fully open, thus allowing air to pass to the second airflow outlet 116 and the first airflow outlet 130 as shown in FIG. 5. This mode is the “driver mode” in which air is directed to the driver only.

The foregoing discussion discloses and describes an exemplary embodiment of the present invention. One skilled in the art will readily recognize from such discussion, and from the accompanying drawings and claims that various changes, modifications and variations can be made therein without departing from the true spirit and fair scope of the invention as defined by the following claims. For example, while the regulation of climates in occupant zones has been generally shown in the figures and described in relation to the figures, it may be desirable to regulate the flow of air only to selected portions of an occupant's body rather than to the occupant's body at large. This may be accomplished through the use of additional ducts which can be adapted through design and placement to provide effective micro-zone climate control.

1.-41. (canceled)

42. A climate control system for attachment to the HVAC of a vehicle having front and rear passenger seating comprising:
a duct network having an HVAC attachment and comprising central vertical and horizontal dividers defining first, second, third and fourth airflow channels;
a first door adjacent said HVAC attachment movable between a position restricting air from entering said first airflow channel to a position allowing air to enter said channel but restricting air from entering said third airflow channel;
a second door adjacent said HVAC attachment movable between a position restricting air from entering said second airflow channel to a position allowing air to enter said channel but restricting air from entering said fourth airflow channel;
whereby airflow may be selectively directed to a front passenger, a rear passenger, or to both.

43. The climate control system of claim 42 wherein said first door defines a single air restricting surface.

44. The climate control system of claim 42 wherein said first door defines a single air restricting surface.

45. The climate control system of claim 42 wherein said first airflow channel is connected to a first outlet, said second airflow channel is connected to a second outlet, said third airflow channel is connected to a third outlet, and said fourth airflow channel is connected to a fourth outlet.

46. The climate control system of claim 42 wherein said first door is a pivotable door.

47. The climate control system of claim 46 wherein said first pivotable door is reversibly movable.

48. The climate control system of claim 46 wherein said first pivotable door is movable to any position between said open position and said closed position.

49. The climate control system of claim 42 wherein said first door is a pivotable door.

50. The climate control system of claim 49 wherein said first pivotable door is reversibly movable.

51. The climate control system of claim 49 wherein said first pivotable door is movable to any position between said open position and said closed position.

52. The climate control system of claim 42 whereby said HVAC attachment is attachable to a plurality of types of HVACs.

53. A climate control system for attachment to the HVAC of a vehicle having front and rear passenger seating comprising:
a duct network having an HVAC attachment and comprising central vertical and horizontal dividers defining first, second, third and fourth airflow channels;
a single air restricting surface defining a first door adjacent said HVAC attachment movable between a position restricting air from entering said first airflow channel to a position allowing air to enter said channel but restricting air from entering said third airflow channel;
a single air restricting surface defining a second door adjacent said HVAC attachment movable between a position restricting air from entering said second airflow channel to a position allowing air to enter said channel but restricting air from entering said fourth airflow channel;
whereby airflow may be selectively directed to a front passenger, a rear passenger, or to both.

54. The climate control system of claim 53 wherein said first airflow channel is connected to a first outlet, said second airflow channel is connected to a second outlet, said third airflow channel is connected to a third outlet, and said fourth airflow channel is connected to a fourth outlet.

55. The climate control system of claim 53 wherein said first door is a pivotable door.

56. The climate control system of claim 55 wherein said first pivotable door is reversibly movable.

57. The climate control system of claim 55 wherein said first pivotable door is movable to any position between said open position and said closed position.

58. The climate control system of claim 53 wherein said first door is a pivotable door.

59. The climate control system of claim 58 wherein said first pivotable door is reversibly movable.

60. The climate control system of claim 58 wherein said first pivotable door is movable to any position between said open position and said closed position.

61. The climate control system of claim 53 whereby said HVAC attachment is attachable to a plurality of types of HVACs.

62. A climate control system for attachment to the HVAC of a vehicle having front and rear passenger seating comprising:
a duct network having an HVAC attachment portion and comprising central vertical and horizontal dividers that define a first airflow channel connected to a first outlet, a second airflow channel connected to a second outlet, a third airflow channel connected to a third outlet, and a fourth airflow channel connected to a fourth outlet, said duct network further including an HVAC attachment portion;
a single air restricting surface defined by a first pivotable door adjacent said HVAC attachment portion and being reversibly movable between a position restricting air from entering said first airflow channel to a position allowing air to enter said channel but restricting air from entering said third airflow channel, said first pivotable door being further movable to any position between said open position and said closed position;
a single air restricting surface defined by a second pivotable door adjacent said HVAC attachment portion and being reversibly movable between a position restricting air from entering said second airflow channel to a position allowing air to enter said channel but restricting air from entering said fourth airflow channel, said second pivotable door being further movable to any position between said open position and said closed position;
whereby airflow may be directed to a front passengers, a rear passenger, or to both a front and rear passenger; and whereby said HVAC portion is attachable to a plurality of types of HVACs.
